(19) United States
(12) Patent Application Publication
(10) Pub. No.: US 2011/0171619 A1
(43) Pub. Date: Jul. 14, 2011

(54) Representation of molecules as sets of masses of complementary subgroups and contiguous complementary subgroups

(76) Inventor: Daniel Leo Sweeney, Arlington Heights, IL (US)

(21) Appl. No.: 12/800,993

(22) Filed: May 27, 2010

Related U.S. Application Data
(60) Provisional application No. 61/217,192, filed on May 28, 2009.
(60) Provisional application No. 61/269,616, filed on Jun. 27, 2009.
(60) Provisional application No. 61/275,052, filed on Aug. 25, 2009.

(51) Int. Cl. G09B 23/26

(52) U.S. Cl. 434/278

(57) ABSTRACT

This invention describes two embodiments of simple representations of molecular structures that are very useful for rapidly identifying unknown compounds from accurate mass fragmentation data generated on a mass spectrometer.

### CROSS REFERENCE TO RELATED APPLICATIONS

USPTO 61217192 (May 28, 2009)

USPTO 61269616 (Jun. 27, 2009)

USPTO 61275052 (Aug. 25, 2009)

### FEDERALLY SPONSORED RESEARCH

Not Applicable

### SEQUENCE LISTING OR PROGRAM

Two C program listings and eight tables are provided on the enclosed duplicate CDs. The file format is ASCII and these files can be read with WordPad or Notepad using the Windows operating system.

| File Name | Size | Type | Date Created | Description | Orientation |
|---|---|---|---|---|---|
| Program_Listing_One | 13 KB | ASCII | Feb. 23, 2011 | ANSI C Program | Portrait |
| Program_Listing_Two | 15 KB | ASCII | Feb. 23, 2011 | ANSI C Program | Portrait |
| Table 1 | 7 KB | ASCII | Feb. 23, 2011 | Table | Portrait |
| Table 2 | 15 KB | ASCII | Feb. 23, 2011 | Table | Portrait |
| Table 3 | 40 KB | ASCII | Feb. 23, 2011 | Table | Portrait |
| Table 4 | 1 KB | ASCII | Feb. 23, 2011 | Table | Portrait |
| Table 5 | 7 KB | ASCII | Feb. 23, 2011 | Table | Portrait |
| Table 6 | 18 KB | ASCII | Feb. 23, 2011 | Table | Portrait |
| Table 7 | 1 KB | ASCII | Feb. 23, 2011 | Table | Portrait |
| Table 8 | 45 KB | ASCII | Feb. 23, 2011 | Table | Landscape |

LENGTHY TABLES
The patent application contains a lengthy table section. A copy of the table is available in electronic form from the USPTO web site (http://seqdata.uspto.gov/?pageRequest=docDetail&DocID=US20110171619A1). An electronic copy of the table will also be available from the USPTO upon request and payment of the fee set forth in 37 CFR 1.19(b)(3).

### BACKGROUND

### Prior Art

The following is a tabulation of some prior art that appears relevant:
1. “Mass Spectral Metabonomics beyond Elemental Formula: Chemical Database Querying by Matching Experimental with Computational Fragmentation Spectra”, D. W. Hill, T. M. Kertesz, D. Fontaine, R. Friedman, and D. F. Grant, Anal. Chem 2008, 80(14), pp 5574-5582
2. Tobias Kind, Using GC-MS, LC-MS and FT-ICR-MS data for structure elucidation of small molecules. Oral presentation at CoSMoS 2007, Society for Small Molecule Science Annual Meeting. San Jose, Calif. Jul. 28, 2008
3. Watson, I. A.; Mahoui, A.; Duckworth, D. C.; Peake, D. A. A strategy for structure confirmation of drug molecules via automated matching of structures with exact mass MS/MS spectra. Proceedings of the 53rd ASMS Conference on Mass Spectrometry, Jun. 5-9, 2005, San Antonio, Tex.; Hill, A.
4. Mortishire-Smith, R. Automated assignment of high-resolution collisionally activated dissociation mass spectra using a systematic bond disconnection approach. Rapid Commun. Mass Spectrom. 2005, 19, 3111-18.
5. http://www.waters.com/waters/nav.htm?locale=en_US&cid=1000943
6. Small Molecules as Mathematical Partitions, Sweeney, D. L. Anal. Chem. 2003, 75(20), 5362-5373
7. D. L. Sweeney, American Laboratory News, 2007, vol. 39 (17), pp. 12-14

### A. Identifying Small Molecules Using Mass Spectrometry

When used to identify an unknown organic compound, a mass spectrometer is basically an instrument that physically breaks up the unknown organic compound into connected groups of atoms called fragments, and then “weighs” the fragments that are produced. Some mass spectrometers can measure the masses of the unknown organic compound and its fragments with extreme accuracy—within 10 ppm of the true masses. Other mass spectrometers are capable of selecting one of the fragments initially produced, colliding that fragment in turn with gases, producing smaller fragments, and measuring the masses of the smaller fragments (MSⁿ).

Besides the masses of the fragments, the mass spectrometer also measures the intensity. A mass spectrometer is not capable of analyzing a single molecule; each spectrum is a sum of fragments of many molecules of the unknown organic compound. When a molecule breaks into two pieces, often only one piece (or fragment) is detected. Some fragments of the compound will be detected well and these will be very intense; some will be less intense; and others may not be detected at all. Taken as a whole, the results obtained by fragmenting and sub-fragmenting the unknown organic compound is its mass spectral data.

Two types of unknown organic compounds can be identified by mass spectrometry: compounds that previously have been identified and catalogued in databases (herein called “known compounds”) and compounds that have not been reported previously (herein called “novel compounds”). When mass spectral data is obtained for a given sample and subsequently interpreted, many unknown compounds in that sample may prove to be known compounds already present in molecular structure databases. In certain fields, such as natural product studies, much time and effort can be spent analyzing the spectra of known compounds, which is very inefficient. This invention principally applies to identifying known compounds from their mass spectral data.

The classical approach for identifying known compounds from their mass spectral data is library matching. A mass spectral library is a computer file containing a summary of the fragment masses and intensities of a large number of compounds that have been previously analyzed by mass spectrometry. In library matching, a search algorithm is used to compare the spectrum of an unknown compound to the fragment masses and intensities of all of the compounds in the library. A list of compounds in the library that best match the unknown compound is then produced. Library matching is especially useful for EI (electron ionization) spectra, because vast libraries of EI spectra exist—the combined NIST and Wiley EI libraries contain hundreds of thousands of spectra. Today only relatively small CID-type (collisionally induced dissociation) mass spectral libraries exist, even though this type of mass spectral data is produced in large volumes by modern LCMS/MS instruments.

### B. Computerized Representations of the Structures of Small Molecules

A computerized representation of a molecule is a file format for holding information about a molecule in such a way that a data processing means can manipulate the information in the file.

A widely used representation is the MDL Molfile format. The Molfile consists of some header information, the Connection Table (CT) containing atom information, then bond connections and types, followed by sections for more complex information. The molfile is sufficiently common that most, if not all, cheminformatics software systems/applications are able to read the format, though not always to the same degree. The connections between the atoms are listed in the connection table, which is a listing of the one-to-one connections of the atoms that make up the molecule.

Alternative computer compatible formats for representing molecular structures include InChi, SMILES, ASN1, and XML type data structures. These computer compatible formats will herein be called computerized molecular structures.

### PRIOR ART

One advantage of searching a library of spectra is that library searches are very fast. Along this line, Hill et. al. used commercial software (Mass Frontier) that predicts mass spectral fragments for a given chemical structure. They then constructed pseudo-fragmentation spectra of some compounds using these computed masses of the predicted fragments. They were then able to search mass spectral data of some known compounds against these computationally derived “spectra” of multiple compounds. This is analogous to library searching. However, it appears that many more fragments are predicted than actually observed and improvements in the predictive software would be needed to make this approach more practicable. Presumably, this would entail the addition of more rules to the predictive software. The predictive software that they used is already very complex. According to Kind, Mass Frontier now has about 20000 rules.

Watson et. al. and Mortishire-Smith et. al. used systematic bond-disconnection to assign accurate-mass fragments to known compounds. Breakable bonds in a molecule are assigned a penalty score based on the likelihood that the bond will break. The rules to determine the penalty are much simpler and fewer than the rules used by the predictive software described previously. The bonds are then systematically broken, up to four at a time, and the masses and elemental compositions of the resulting pieces were found. Redundant masses and compositions were then removed. The masses of the fragment ions, obtained from the mass spectral data, are then compared to the calculated masses taking into account that the mass may differ by the number of hydrogens lost or gained in forming the fragment ion. If multiple pieces had the same mass and formula, the corresponding partial structures would be displayed. This approach has been applied to the assignment of fragment ions observed in a mass spectrum and for metabolite identification by comparison to the parent drug; the software is called “MassFragment”. According to Waters Corporation, MassFragment assigns structures to observed fragment ions of small molecule compounds, drugs, and/or metabolites by systematic bond disconnection of the precursor structure instead of the traditional rule-based approach.

Sweeney described in great detail a process for deriving modular structures directly from CID-type mass spectral data; this process will herein be called partitioning. The fragmentation of an organic compound in a mass spectrometer is not a random breaking of bonds; the breaking of a select group of bonds of the unknown organic compound yielding complementary subfragments can often account for most of the observed mass spectral fragments. This is the underlying principle of partitioning. Most organic compounds can therefore be represented in the form of unbreakable subfragments, of known elemental composition, joined together by breakable bonds. Modular structures basically show how mass spectral fragments may be related to one another.

Based on systematic bond disconnection and partitioning, Sweeney commercially introduced a software program in December 2006 to search the MDL® (now Symyx) Available Chemicals Directory (Rational Numbers® FragSearch) with accurate-mass mass spectral data for the purpose of identifying unknown compounds. Rational Numbers® Search software was comprised of a data processing means and four other major components. First, computerized molecular structures were represented in an abbreviated version of MDL Molfile format. Second, the mass spectral data of the unknown compound was analyzed by the data processing means and converted into plausible modular structures, connected groups of subfragments of known elemental composition. Third, all computerized molecular structures in the database having a molecular weight similar to the unknown compound were broken by systematic bond disconnection into complementary subgroups (connected groups of atoms that together with the other subgroups comprise a whole molecule; each heavy atom in a molecule can only be found in one subgroup). These connected subgroups were analogous to the modular structures derived from mass spectral fragmentation data by partitioning. Fourth, the heavy atom compositions of the connected subgroups and the modular structures were then compared using the data processing means.

An example of a modular structure of an organic compound is xemilofiban (PubChem ID 3033830). This compound is shown in FIG. 1 in two formats; the modular structure is shown below the corresponding molecular structure. The modular structure shown in FIG. 1 is a convenient way of summarizing and viewing CID-type mass spectral data. Each modular structure has a molecular formula. The fragment ions are viewed as different sets of contiguous subfragments; each subfragment has an elemental composition that is complementary to all of the other subfragments comprising the modular structure. For example, if the elemental composition of the whole molecule has only one sulfur atom, then assigning that sulfur atom to one particular subfragment will preclude all of other subfragments from having a sulfur atom.

Every search requires that the molecules in the database with masses corresponding to the unknown compound must be broken by “systematic bond disconnection” for comparison with each of the possible modular structures of the unknown. Partitioning and systematic bond disconnection, required for searching this way, are both very CPU intensive, especially for larger molecules with more bonds and more partitions. The original version of Rational Numbers Search ran on a Mac mini and the process was very slow, often taking hours. To provide faster results to users, a much more powerful data processing means than a single workstation was employed. The Rational Numbers® Search application was provided to users as an application on the Sun Grid Compute Utility (SGCU, later called the Sun Cloud). This utility provided a very powerful data processing means by allowing searches to be conducted in parallel on multiple 64-bit Opteron processors. Rational Numbers® Search software was not commercially successful; obtaining a SGCU account and paying for the service was cumbersome. The Sun Grid Compute Utility, never fully implemented by Sun, was abandoned by Sun Microsystems in October 2008. The utility and commercial success of Rational Numbers® Search software appeared to be constrained by a lack of available and easy-to-use high throughput CPU resources.

From a different perspective, although there are many formats for representing chemical structures on a computer, no present representation is really conducive to rapid mass spectral searching. A representation of PubChem ID# 3303830 (xemilofiban) is shown in SMILES format (CCOC(=O)CC(C#C)NC(=O)CCC(=O)NC1=CC=C(C=C1)C(=N)N.Cl), Molfile format (Table 1), ASN1 format (Table 2), XML format (Table 3), and the abbreviated version of Molfile format used by Rational Numbers Search (Table 4).

### DRAWINGS

FIG. 1: A modular structure of xemilofiban (1) is compared to a molecular structure (2).

FIG. 2: Molecular structures of PubChem ID (CID) 3033830 (1), 9946860 (2), 6399441 (3), and 60807 (4).

FIG. 3: Atom Numbering of CID 3033830, xemilofiban.

### DETAILED DESCRIPTION OF THE PREFERRED EMBODIMENT

In the preferred embodiment, a molecule is represented by a set of partitions of subgroups of exact mass which comprise the molecule, where said exact masses of subgroups include the exact mass of a hydrogen atom in place of a broken single bond or the mass of two hydrogen atoms in place of a broken double bond, and a unique ID number. Table 5 illustrates the 4-subgroup set of partitions that represent the compound PubChem ID 3033830, xemilofiban. In this 4-subgroup example, each row represents a different and unique partition of the molecule. The first four columns are the exact masses (in units of tenths of millidaltons) of each complementary subgroup (SG) designated as subgroups A to D. The fifth column is the compound identifier 3033830.

Some Features of this Embodiment:

The exact masses of subgroups in Table 5 equals the exact mass of the corresponding part of the molecule, except that the exact mass of a hydrogen atom was added wherever a bond was disconnected. In the case of double bonds, the mass of two hydrogens was added. For the simplicity of working with only integers, the masses of the subgroups derived from the chemical structures are in units of tenths of millidaltons.

When molecules are fragmented in a mass spectrometer, the fragments generated will often differ from the corresponding part of the whole molecule in the number of hydrogens. By adding the mass of a hydrogen atom wherever a bond was broken, this assures that the subgroup will always be greater than or equal to its mass contribution in a corresponding fragment ion when searching is done. If greater, it should differ by some integral number multiplied by the exact mass of a hydrogen atom.

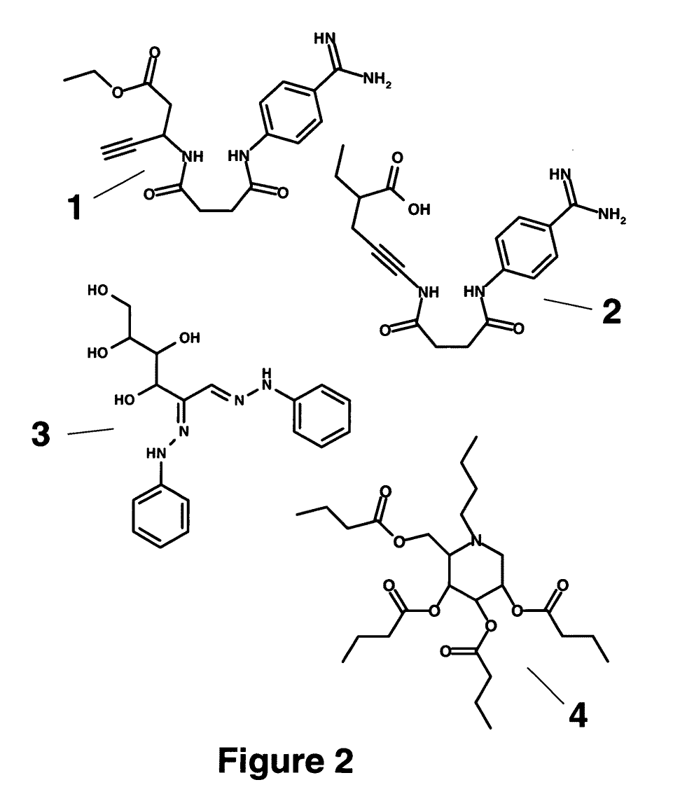

Some compounds have subgroups of identical mass. For example, PubChem ID# 60807 (FIG. 2) has four identical butyrate groups and systematic bond disconnection will generate a considerable number of identical partitions for compounds like this. However, only one of the identical sets is saved in this representation of the compound. This cuts down on the number of sets and eliminates essentially duplicate answers that otherwise would arise. In this embodiment, each of the partitions in a set representing a given compound are unique.

Sets with various numbers of subgroup masses are generated. For example, each molecule could be broken into sets of 2 subgroups, 3 subgroups, 4 subgroups, 5 subgroups, etc.

### How the Representations are Made

First, some bonds of compounds that are being represented have been “locked”. There is no attempt to score each bond on how likely that particular bond may break. Either a bond can break or not break (locked). For example, it is very unusual for a benzene ring to fragment under CID fragmentation conditions—unless one of the carbon atoms of the ring is attached to an activating group such as an oxygen. Therefore the ring bonds in most molecules containing benzene and naphthalene rings are locked. In addition, the bonds of aliphatic hydrocarbon chains are also locked. Triple bonds are locked. The consequences of locking some bonds are that the number of partitions is fewer and searching is therefore faster.

Based on the representation of a molecular structure in molfile format, systematic bond disconnection is applied to breakable bonds in the structure and the structure is broken into pieces. A 4-subgroup representation will be used to illustrate how the representations are made. The objective therefore is to break the molecule into four pieces in which each heavy atom (and its attached hydrogens) is found in only one of the four pieces; the pieces are complementary. To break a molecule into four pieces, at least three bonds must be broken simultaneously. If cyclic moieties are present, then it might be necessary to break four, five, or more bonds to get four pieces. To generate representations of 4 subgroups, the systematic bond disconnection is therefore applied to combinations of all breakable bonds, taking 3, 4 or 5 bonds at a time. Often the wrong number of pieces (2, 3, 5 etc) might be generated; these are rejected. When 4 pieces that are partitions of complementary subgroups that comprise the whole molecule are generated, the exact mass of each complementary subgroup is then calculated. Because the exact mass of each heavy atom in a subgroup can only be found in one subgroup of exact masses, each molecule is “partitioned” into exact masses of subgroups. In this embodiment, the exact mass of a hydrogen atom is added to any subgroup where there was a broken bond; the exact mass of two hydrogens is added if the broken bond was a double bond. Triple bonds are locked.

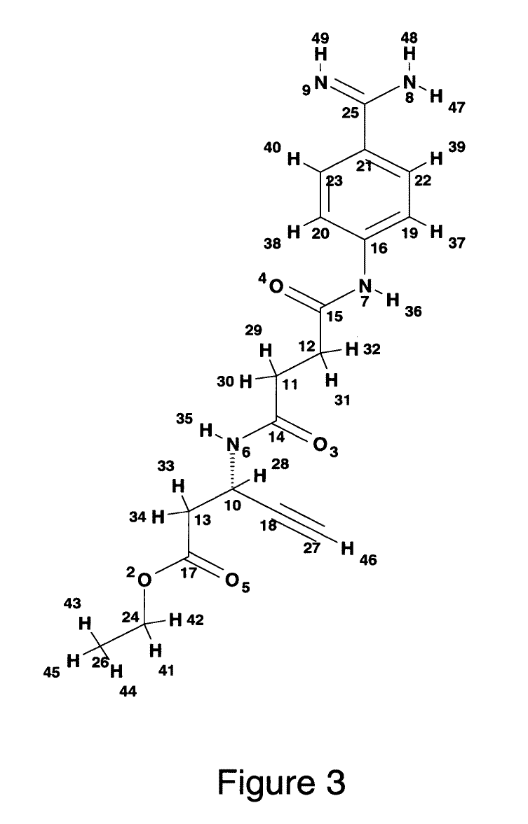

As each partition of exact masses of subgroups is generated and found, the exact masses of the four subgroups are sorted by the data processing means in numerical order. As shown here, subgroup A (SG A) is the smallest subgroup, and subgroup D is the largest. Generating the set of partitions of exact masses of 4 subgroups for the compound PubChem ID 3033830, xemilofiban, is shown in Table 6. The atoms of PubChem ID 3033830 are numbered as shown in FIG. 3. (Note: atom one was the chlorine atom of this HCL salt, which was removed during indexing.) The first four columns have been numerically sorted. In this embodiment, an identifying compound ID number is added in the fifth position. The atom pairs that were disconnected to generate the partitions are shown here at the right side for illustrative purposes. At this point many of the rows are redundant. After the set of partitions of exact masses of 4 subgroups for an individual molecule are generated, the set is sorted in numerical order (using the Linux sort −nr command). In the example (Table 6) this represents sorting rows while keeping the columns the same. At this point many rows are identical. By applying the Linux sort −u command redundant rows are removed.

It is often possible to have both a double bond and single bond that can break and give almost the same set of subgroups. For example, the amidine group of xemilofiban (FIG. 3) has two nitrogens; one nitrogen (atom 9) is connected to the carbon (atom number 25) with a double bond and the other nitrogen (atom 8) with a single bond. Since the mass of one hydrogen is added to each side if a single bond breaks, and the mass of two hydrogens is added if a double bond breaks, in the respective partitions of exact masses of the corresponding subgroups will differ by the mass of two hydrogens. These are essentially duplicates. These “duplicates” are found by comparing the remaining rows and finding rows where the corresponding subgroups differ by the mass of an integral number of hydrogens. When these rows are found, the partition of exact masses of subgroups with the individual subgroup of greater mass is removed. This is the final step in generating the set of partitions of exact masses of subgroups for this embodiment.

Use of this Embodiment

The sets of partitions of exact masses of subgroups, and sums of all combinations of these exact masses which are easily computed by the data processing means, can be compared to the exact masses of fragment ions generated on the mass spectrometer, while taking into account that the subgroups and combinations of subgroups will often exceed the mass of the corresponding fragment ion by some multiple of the exact mass of a hydrogen atom. Comparison by the data processing means between mass spectral fragmentation data and these representations is very rapid. The basic process for searching is briefly described here. (The detailed process by which exact masses of subgroups and combinations of subgroups are compared to fragment ion data is shown in great detail as Program Listing 1. This illustrative program is written in ANSI C.)

First the representations of molecules having the same integral molecular weight as the unknown compound are inputted by the data processing means and stored in an array. Then a partition of subgroups of exact mass is selected and all combinations of these exact masses are computed by the data processing means. The comparison is done by selecting a fragment ion mass from the mass spectral data generated on a the mass spectrometer and comparing its mass to the masses of all of the combinations of the partition. If the mass difference is within the MaxDefect window, the score for that partition is increased by the coverage value of that fragment ion. (The MaxDefect window is the error allowed (in tenths of milliDaltons) in experimentally measured masses (mass spectral data) versus the theoretical exact masses of subgroups and can vary from instrument to instrument. The coverage is a scoring number based on the intensity of a given fragment ion; intense fragment ions have a greater coverage value than weakly detected fragment ions.) If no matches are found, the exact masses of the combinations of subgroups are then decreased by the exact mass of one hydrogen atom. This comparison process is repeated until a maximum number of exact masses of hydrogen atoms (arbitrary number) is subtracted. This same approach is then repeated for the next fragment ion.

After all of the fragment ions are compared, a score is then calculated for that partition and the next partition of subgroups of exact mass is then tested.

In this embodiment, no partitioning of the mass spectral data to find the exact masses of subfragments is needed. Previously, linked partitions were removed during the partitioning process. Flags AtoB, AtoC, AtoD, BtoC, BtoD, and CtoD in Program Listing 1 are used to check for linkage. By using flags in this way, linked partitions can be detected and removed; searching can therefore be done without prior partitioning of the mass spectral data and this further improves the searching speed.

Below is an example of searching for xemilofiban (PubChem ID 3033830), comparing the masses and intensities of fragments of CID 3033830 generated on a Q-tof mass spectrometer to sets of partitions of subgroups of exact mass which comprise said molecule and sums of exact masses of all combinations of subgroups Note that the database searched had about 70000 common compounds, but the actual search process was in this example limited to those 153 compounds having the same nominal mass as xemilofiban. This search took about one second.

As previously noted, the scores take into account the intensity of the observed fragments. The MS/MS data obtained on PubChem ID 3033830 and previously published (Reference 6) is listed below—masses followed by intensity:

95.0367
2
118.0522
2
124.0525
3
135.0800
47
141.0790
2
175.0643
3
177.0430
17
200.0590
19
216.1018
2
217.0856
100
223.0851
6
358.1642
0

Search Results (after sorting by score):

| Score | PubChemID | sbgrp1 | sbgrp2 | sbgrp3 | sbgrp4 |
|---|---|---|---|---|---|
| 93 | PubChemID 3033830 | 460419 | 860368 | 970528 | 1350796 |
| 90 | PubChemID 9946860 | 170265 | 860368 | 1200687 | 1410790 |
| 90 | PubChemID 3033830 | 170265 | 860368 | 1200687 | 1410790 |
| 85 | PubChemID 3033830 | 170265 | 880524 | 1200687 | 1390633 |
| 79 | PubChemID 3033830 | 440262 | 460419 | 1350796 | 1390633 |
| 78 | PubChemID 3033830 | 400313 | 880524 | 1010477 | 1350796 |
| 76 | PubChemID 9946860 | 170265 | 860368 | 1260681 | 1350796 |
| 76 | PubChemID 3033830 | 550422 | 860368 | 880524 | 1350796 |
| 76 | PubChemID 3033830 | 170265 | 860368 | 1260681 | 1350796 |
| 70 | PubChemID 9946860 | 440626 | 460055 | 1350796 | 1390633 |
| 66 | PubChemID 3033830 | 550422 | 880524 | 1010477 | 1200687 |
| 62 | PubChemID 9946860 | 170265 | 1010477 | 1050578 | 1410790 |
| 61 | PubChemID 3033830 | 170265 | 460419 | 970528 | 2040899 |
| 60 | PubChemID 9946860 | 170265 | 170265 | 1260681 | 2040899 |
| 60 | PubChemID 3033830 | 170265 | 170265 | 1260681 | 2040899 |
| 55 | PubChemID 3033830 | 460419 | 970528 | 1010477 | 1200687 |
| 54 | PubChemID 3033830 | 460419 | 820419 | 1010477 | 1350796 |
| 53 | PubChemID 9946860 | 170265 | 1050578 | 1160586 | 1260681 |
| 53 | PubChemID 3033830 | 170265 | 1050578 | 1160586 | 1260681 |
| 52 | PubChemID 3033830 | 170265 | 460419 | 820419 | 2191008 |
| 51 | PubChemID 9946860 | 170265 | 180106 | 1260681 | 2051215 |
| 51 | PubChemID 3033830 | 170265 | 460419 | 1200687 | 1810739 |
| 51 | PubChemID 3033830 | 170265 | 180106 | 1260681 | 2051215 |
| 48 | PubChemID 3033830 | 300106 | 690578 | 740368 | 1911059 |
| 47 | PubChemID 3033830 | 180106 | 600575 | 1250841 | 1630746 |
| 43 | PubChemID 9946860 | 180106 | 870684 | 1260681 | 1350796 |
| 43 | PubChemID 3033830 | 180106 | 870684 | 1260681 | 1350796 |
| 41 | PubChemID 9946860 | 180106 | 180106 | 1250841 | 2051215 |
| 41 | PubChemID 3033830 | 180106 | 180106 | 1270997 | 2051215 |
| 40 | PubChemID 6399441 | 440374 | 780470 | 930578 | 1490688 |
| 39 | PubChemID 6399441 | 290265 | 930578 | 1080687 | 1360736 |
| 30 | PubChemID 3033830 | 400313 | 880524 | 1160586 | 1200687 |
| 25 | PubChemID 6399441 | 290265 | 920473 | 930578 | 1500793 |

real 0m1.302s
user 0m1.016s
sys 0m0.021s

The top answer, 460419, 860368, 970528, and 1350796 set of subgroups above, arises from breaking the bonds between the following pairs of atoms in xemilofiban: 2 to 17; 6 to 14 and 7 to 15. These bonds in xemilofiban were shown in FIG. 3.

Note that all three compounds found above, CID 3033830, CID 9946860, and CID 6399441 have the same elemental composition. CID 9946860 is very closely related to CID 3033830 whereas CID 6399441 is quite different structurally. These structures are compared in FIG. 2.

The advantages of the preferred embodiment is that searching is very fast and the representations are relatively small files.

### DETAILED DESCRIPTION OF AN ALTERNATIVE EMBODIMENT

In the alternative embodiment, a molecule is represented by sets of partitions of subgroups of exact mass which comprise said molecule and sums of exact masses of combinations of contiguous subgroups where the ordering of said subgroups and sums of combinations of said subgroups in the sets designates particular combinations of said subgroups; the number zero replaces sums of exact masses of combinations of subgroups which are non-contiguous; the mass of the combination that includes all subgroups is replaced with the exact mass of the molecule; and exact masses of subgroups includes the exact mass of a hydrogen atom in place of a broken single bond or the mass of two hydrogen atoms in place of a broken double bond. This is best shown by example.

Here is one of the many 4-subgroup set of partitions of exact masses of subgroups that represent, in this embodiment, the compound PubChem ID 3033830, xemilofiban:

| | | | | | | |
|---|---|---|---|---|---|---|
| | | | | 460419 | 970528 | |
| 860368 | 1350796 | 1430947 | 0 0 | 1830896 | 0 | 2211164 |
| 2291315 | 0 0 | 3181692 | 3581641 | 3033830 | | |

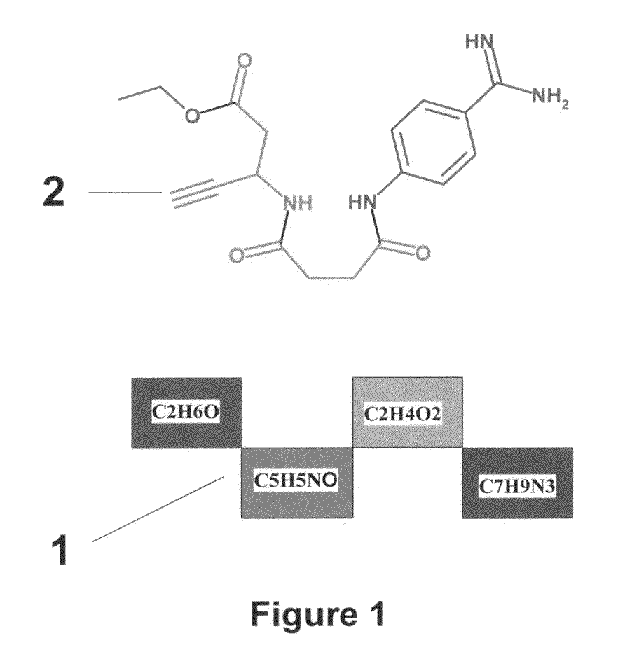

Each row represents a different and unique partition of the molecule. This partition was generated by disconnecting the bonds between atom pairs 2,17; 6,14; and 7,15 (see FIG. 3). In FIG. 1, SubGroupA is blue; SubGroupB is magenta; SubGroupC is orange; and SubGroupD is green. Table 7 shows the ordering of the assignments.

The 4-subfragment representation of CID 3033830 in this embodiment is shown in Table 8.

Some Features of this Embodiment:

The major difference between this embodiment and the preferred embodiment is that in the preferred embodiment every combination of subgroups is considered feasible, whereas in this embodiment if a combination is composed of subgroups that are not contiguous to each other in the molecule, an exact mass of zero is entered in place of the sum of the masses of the subgroups. This representation results in larger files than the preferred embodiment.

By adding the mass of a hydrogen atom wherever a bond was broken, this assures that the subgroup will always be greater than or equal to its mass contribution in a corresponding fragment ion when searching is done. If greater, it should differ by some integral number multiplied by the exact mass of a hydrogen atom.

Sets with various numbers of subgroup masses are generated. For example, each molecule could be broken into sets of 2 subgroups, 3 subgroups, 4 subgroups, 5 subgroups, etc.

How the Representations for this Embodiment are Made

The exact masses of subgroups are found with the same approach that was used for the preferred embodiment with the addition of a check to determine whether a combination of subgroups is contiguous. Two subgroups are contiguous if each subgroup has one atom of a disconnected pair. In the example above, the bond between atoms 2 and 17 was one of three bonds that were disconnected. SubGroupA had atom 2 in it and SubGroupB had atom 17 in it. Therefore these two subgroups are contiguous. In a similar fashion, the bond between atoms 6 (in SubGroupB) and 14 (in SubGroupC) were disconnected; therefore SubGroupB is contiguous to SubGroupC. By logical inference, since both SubGroupA and SubGroupC are contiguous to SubGroupB, the three subgroup combination SubGroupA+SubGroupB+SubGroupC (2291315) is also contiguous. If a combination contains subgroups (e.g. SubGroupA+SubGroupC) which are not contiguous, then that combination is given a mass of zero.

There is an additional step: the combination of all subgroups is replaced with the exact mass of the whole molecule. At this point the ordering of the subgroups and sums of combinations of said subgroups in the sets designates particular combinations of subgroups and the number zero replaces sums of exact masses of combinations of subgroups which are non-contiguous.

Removing redundant partitions is more complex than in the preferred embodiment. The partitions that are generated are stored essentially in duplicate. The first replicate is sorted in the following way: First the subgroups are sorted in numerical order and placed in positions 1 to 4. Then the combinations (including the zeroes) are sorted numerically in positions 5 to 14. The second replicate retains the original ordering.

After the set of partitions of exact masses of 4 subgroups for an individual molecule are generated and sorted as above, the set is sorted in numerical order (using the Linux sort −nr command), but only sorting on the first 14 positions. This represents sorting rows while keeping the columns or positions the same. At this point many rows are identical. By applying the Linux sort −u command rows which are redundant in positions 1 to 14 are then removed.

As before, it is often possible to have both a double bond and single bond that can break and give almost the same set of subgroups. For example, the amidine group of xemilofiban (FIG. 3) has two nitrogens; one nitrogen (atom 9) is connected to the carbon (atom number 25) with a double bond and the other nitrogen (atom 8) with a single bond. Since the mass of one hydrogen is added to each side if a single bond breaks, and the mass of two hydrogens is added if a double bond breaks, in the respective partitions of exact masses of the corresponding subgroups and combinations of exact masses of subgroups will differ by the mass of an integral number of hydrogens. These are essentially duplicates. These “duplicates” are found by comparing the first 14 positions of remaining rows and finding rows where the corresponding masses differ by the mass of an integral number of hydrogens. When these rows are found, the partition of exact masses of greater mass is removed.

Now, for the remaining partitions in the set, only the second replicate is retained so the ordering of the subgroups and sums of combinations of the subgroups in the sets designates particular combinations of subgroups. This is the final step in generating the set of partitions of exact masses of subgroups for this embodiment.

Use of this Embodiment

The detailed process by which combinations of subgroups and connected subgroups can be compared to fragment ion data is shown in great detail as Program Listing 2. This illustrative program is written in ANSI C.

This embodiment is used for searching in essentially the same way as the preferred embodiment. By storing the exact mass of the molecule in place of the whole molecule, only those partitions of molecules having an exact mass within the MaxDefect window of the experimentally determined accurate mass of the unknown compound need to be checked. In addition, the sums of all combinations of exact masses of subgroups is not computed since the exact masses of contiguous subgroups are in the representation.

Below is an example of searching for xemilofiban (PubChem ID 3033830), comparing the masses and intensities of fragments of CID 3033830 generated on a Q-tof mass spectrometer and previously shown in the preferred embodiment to masses of subgroups and connected subgroups where molecules have been partitioned into subgroups of 4 elements. In this example, the database of representations that was searched had a little over 60000 common compounds, but the actual search process was limited to those 153 compounds having the same nominal mass as xemilofiban (MW 358). This search took about 4.686 seconds; the 153 compounds had a total of 89039 partitions.

Search Results (after sorting by score):

| Score | PubChemID | SG A | SG B | SG C | SG D |
|---|---|---|---|---|---|
| 93 | PubChemID 3033830 | 460419 | 970528 | 860368 | 1350796 |
| 90 | PubChemID 9946860 | 1200687 | 860368 | 1410790 | 170265 |
| 90 | PubChemID 3033830 | 1410790 | 860368 | 1200687 | 170265 |
| 77 | PubChemID 9946860 | 1200687 | 1010477 | 1260681 | 170265 |
| 77 | PubChemID 3033830 | 1260681 | 1010477 | 1200687 | 170265 |
| 76 | PubChemID 9946860 | 170265 | 860368 | 1200687 | 1410790 |
| 76 | PubChemID 3033830 | 1260681 | 170265 | 860368 | 1350796 |
| 75 | PubChemID 9946860 | 1350796 | 860368 | 170265 | 1260681 |
| 75 | PubChemID 3033830 | 1410790 | 860368 | 170265 | 1200687 |
| 72 | PubChemID 3033830 | 550422 | 860368 | 1350796 | 880524 |
| 63 | PubChemID 9946860 | 1010477 | 1050578 | 1410790 | 170265 |
| 63 | PubChemID 3033830 | 1410790 | 1010477 | 1050578 | 170265 |
| 61 | PubChemID 3033830 | 460419 | 970528 | 2040899 | 170265 |
| 60 | PubChemID 9946860 | 170265 | 2040899 | 1260681 | 170265 |
| 60 | PubChemID 3033830 | 1260681 | 170265 | 2040899 | 170265 |
| 55 | PubChemID 9946860 | 2061055 | 1260681 | 170265 | 170265 |
| 55 | PubChemID 3033830 | 460419 | 970528 | 1010477 | 1200687 |
| 55 | PubChemID 3033830 | 1260681 | 2061055 | 170265 | 170265 |
| 54 | PubChemID 3033830 | 460419 | 820419 | 1010477 | 1350796 |
| 53 | PubChemID 9946860 | 1010477 | 1200687 | 170265 | 1260681 |
| 52 | PubChemID 3033830 | 460419 | 820419 | 170265 | 2191008 |
| 52 | PubChemID 3033830 | 1260681 | 170265 | 1010477 | 1200687 |
| 51 | PubChemID 9946860 | 180106 | 2051215 | 170265 | 1260681 |
| 51 | PubChemID 3033830 | 460419 | 1810739 | 1200687 | 170265 |
| 51 | PubChemID 3033830 | 180106 | 2051215 | 1260681 | 170265 |
| 50 | PubChemID 3033830 | 460419 | 1810739 | 170265 | 1200687 |
| 49 | PubChemID 9946860 | 1160586 | 1050578 | 1260681 | 170265 |
| 49 | PubChemID 3033830 | 1260681 | 1160586 | 1050578 | 170265 |
| 46 | PubChemID 9946860 | 180106 | 2051215 | 1260681 | 170265 |
| 46 | PubChemID 3033830 | 690578 | 300106 | 1911059 | 740368 |
| 46 | PubChemID 3033830 | 180106 | 2051215 | 1260681 | 170265 |
| 43 | PubChemID 9946860 | 170265 | 1010477 | 1200687 | 1260681 |
| 43 | PubChemID 3033830 | 400313 | 1010477 | 1350796 | 880524 |
| 43 | PubChemID 3033830 | 180106 | 870684 | 1260681 | 1350796 |
| 42 | PubChemID 9946860 | 180106 | 870684 | 1350796 | 1260681 |
| 42 | PubChemID 3033830 | 1260681 | 1010477 | 170265 | 1200687 |

The top answer, 460419, 860368, 970528, and 1350796 set of subgroups above, arises from breaking the bonds between the following pairs of atoms in xemilofiban: 2 to 17; 6 to 14 and 7 to 15. These bonds in xemilofiban were shown in FIG. 3. The subgroups are listed in the results here for illustration purposes.

Note that both compounds found above, CID 3033830 and CID 9946860, have the same elemental composition and CID 9946860 is very closely related to CID 3033830. Searching all combinations of subgroups (as demonstrated in the preferred embodiment), CID 6399441 was also found albeit with a low score; CID 6399441 is quite different structurally although its elemental composition is identical to CID 3033830 and CID 9946860. As expected this embodiment is better at excluding incorrect answers than the preferred embodiment and CID 6399441 was not found. All three structures are shown in FIG. 2.

Another feature of this embodiment is that, unlike the preferred embodiment, the same set of subgroups can give different scores, since they could arise from partitioning the molecule in different ways. From the searching results above:

| | | | | | |
|---|---|---|---|---|---|
| 77 | PubChemID | 1260681 | 1010477 | 1200687 | 170265 |
| | 3033830 | | | | |
| 52 | PubChemID | 1260681 | 170265 | 1010477 | 1200687 |
| | 3033830 | | | | |
| 42 | PubChemID | 1260681 | 1010477 | 170265 | 1200687 |
| | 3033830 | | | | |

These three partitions arise from breaking four different sets of three bonds; these partitions are the 2^{nd}, 3^{rd}, and 4^{th} partitions in Table 8.

Advantages of these Representations

The big advantage is speed. The slow process of systematic bond disconnection is no longer part of the actual search process. In addition, there is no need to convert back and forth between elemental compositions and masses. Both the representation of chemical structures and the fragmentation data are formatted as numbers.

In addition, there is no need to do prior partitioning of the mass spectral data. Partitioning, through systematic bond disconnection, is only done on the molecular structures. Previously, partitioning was done on the mass spectral data and one perceived advantage was that partitioning was able to eliminate “linked partitions”. Linked partitions are basically partitions that use two elements where one element would suffice to achieve the same score. However, as shown in the program listing, by using flags it is possible to eliminate linked partitions without partitioning the mass spectral data.

The second advantage is simplicity. There are very few rules with respect to bond breaking. It is difficult to predict how a given compound will fragment in a mass spectrometer even with 20000 rules. Here, there is no need to score how likely a given bond is to break; bonds are classified only as locked or breakable. This simplicity also makes it possible to use a data processing means such as CUDA that has fewer registers available for programming.

### RAMIFICATIONS

It is possible to easily take MSⁿ data into account. For example, assume a precursor ion is composed of contiguous subgroups A and B. Then, when this precursor ion is fragmented, it cannot produce any product ion containing subgroup C or D. The availability and use of MSⁿ data in this way can make the searching much more selective. This capability of using MSⁿ data is the reason that formatting contiguous subfragments in a particular order in the alternative embodiment is so useful.

It should be possible to find related compounds having a different nominal molecular weight if an unknown compound is not present in the database of representations. For example, xemilofiban (CID 3033830) is an ethyl ester. Let us say that an unknown compound was the corresponding isopropyl ester. A search could be done across the entire database, looking to match three of four subgroups. This isopropyl analog would no doubt match three (860368, 970528, and 1350796) of the four subgroups that had top score for CID 3033830 since the 460419 is the only subgroup that contains the ethanol moiety. When searching in this manner, both the subgroup masses and contiguous subgroup masses could be used.

This representation of molecular structures is very simple and well suited for GPU processing with CUDA and similar multi-CPU approaches to high-throughput computing. In CUDA, a half warp of 16 threads is an ideal size array to work with. The alternative embodiment representation illustrated herein is composed of 16 integers made up of 4 subgroups, 11 combinations of subgroups and 1 PubChem ID. If partitions of 5 elements were used, that would generate a 32 integer representation which is two half warps.

Although the search example illustrated here was from a small database with representations for only about 60000 compounds, the new representation would also be suited for a much larger database such as PubChem. The search space could be limited to a very narrow mass slice around the unknown compound. This would help keep the search time down.

The number of sets of subgroups required to represent a chemical compound will increase with the molecular weight and number of bonds in the compound. However, since there are fewer higher mass compounds, there is not much difference in the total number of sets of masses as the molecular weight increases. Thus search times should not vary significantly with the molecular weight of the unknowns.

This representation of molecular structures could also be used to identify subfragments generated from EI spectral data and indeed any type of mass spectral fragmentation data.

Instead of subtracting hydrogens from the representations, we could add hydrogens to the neutralized fragment ions. Representations are shown in table format for ease of illustration only. The representations do not have to be in table format.

### DEFINITIONS

Accurate-mass mass spectral data: mass spectral data that is accurate to 10 ppm accuracy or better, generally represented as a four or five decimal-place rational number.
CID-type spectral data: mass spectral fragmentation data arising from collision-induced dissociation (collisionally activated dissociation) of a parent ion. This spectral data including, but not limited to, in-source fragmentation, MS/MS fragmentation, and MS″ fragmentation.
computerized molecular structure: a representation of an organic compound in a computerized format including, but not limited to, molfile, SMILES, and InChi files.
contiguous subgroups: a combination of subgroups that are connected in the original molecule without any breaks
connection table: A connection table (Ctab) is a description of the structural relationships of the collection of atoms comprising an organic compound, herein referring mainly to the atom block, the bond block, and the ID number.
database: a computer file containing a number of representations of molecular structures.
EI spectral data: mass spectral fragmentation data arising from electron ionization
FT-ICR mass spectrometer: Fourier transform ion-cyclotron resonance mass spectrometer, also known as FTMS.
fragment ion: a set of connected atoms arising from the cleavage of an organic compound in a mass spectrometer.
heavy atom: a non-hydrogen atom in a computerized molecular structure
InChi: The International Union of Pure & Applied Chemistry (IUPAC) has developed the International Chemical Identifier (InChi) as a non-proprietary identifier for chemical substances.
Indexing: the process of converting the mass of computerized molecular structures into the mass that would be observed using ESI type ionization (e.g. converting an amine hydrochlorides into the corresponding free base; converting a sodium salt into a free acid. See Reference 7)
known compound: an organic compound that has been identified and documented in a database or databases.
library: a computer file containing a summary of the fragment masses and intensities of a number of compounds that have been analyzed by mass spectrometry.
linked subgroups: subgroups that are always assigned together such that their sum could be substituted and the same score obtained with one less subgroup modular structure: a representation of an organic compound as a small number of unbreakable subfragments, of known elemental composition, joined together in a two-dimensional spatial arrangement.
molecular structure: a two-dimensional representation (drawing) of an organic compound.
molfile: a computerized representation of an organic compound in a connection table format
MSMS: (mass spectrometry—mass spectrometry or MS/MS) a mass spectral technique that produces fragment ions from a precursor ion, by using an instrument that is tandem in time or tandem in space.
MSⁿ: any mass spectral technique that produces fragment ions of fragment ions, where n indicates the number of levels of fragmentation.
neutralized fragment ion: a fragment that would result if a proton were added or removed in order to neutralize the charge on a fragment ion.
NIST: National Institute of Standards and Testing
novel compound: a compound that has not been documented previously
partition: mathematically, a partition is a set of integers that sum up to another integer. Here the term partition is used to describe a set of masses originating from a molecule which has been broken into a number of complementary subgroups.
partitioning: the process for deriving subgroups from a molecular structure through the process of systematic bond disconnection.
seam: a breakable connection point between subfragments of a modular structure
searching: comparing accurate mass fragmentation data of an unknown compound to representations of many compounds in a database
SMILES: a line notation format that uses character strings to represent the structure of an organic compound (Simplified Molecule Input Line Entry System)
subfragment: a set of connected atoms that make up one unit of a modular structure.
subgroup: connected atoms that together with all of the other subgroups in a partition comprise a whole molecule. Each atom in a molecule can only be found in one subgroup of a partition.
unknown compound: a compound under investigation that will prove to be either a known compound or a novel compound.

I claim:

1. A representation of a molecule as:
a set of partitions of subgroups of exact mass which comprise said molecule,

2. the representation of claim 1 where said subgroups include the exact mass of a hydrogen atom in place of a disconnected single bond or the exact mass of two hydrogen atoms in place of a broken double bond,

3. the representation of claim 1 where said sets include a unique compound identifier

4. the representation of claim 2 where said sets include a unique compound identifier,

5. A representation of a molecule as:
sets of partitions of subgroups of exact mass which comprise said molecule and sums of exact masses of combinations of contiguous subgroups,

6. the representation of claim 5 where the ordering of said subgroups and sums of combinations of said subgroups in the sets designates particular combinations of said subgroups and the number zero replaces sums of exact masses of combinations of subgroups which are non-contiguous,

7. the representation of claim 5 where said sets include a unique compound identifier,

8. the representation of claim 5 where said exact masses of subgroups includes the exact mass of a hydrogen atom in place of a broken single bond or the mass of two hydrogen atoms in place of a broken double bond,

9. the representation of claim 5 where the mass of the combination that includes all subgroups is replaced with the exact mass of the molecule,

10. the representation of claim 6 where said sets include a unique compound identifier,

11. the representation of claim 6 where the mass of the combination that includes all subgroups is replaced with the exact mass of the molecule,

12. the representation of claim 6 where said exact masses of subgroups includes the exact mass of a hydrogen atom in place of a broken single bond or the mass of two hydrogen atoms in place of a broken double bond,
whereby,
an unknown compound can be rapidly identified or characterized by comparing the masses of its fragment ions, measured on a mass spectrometer, to said representation.
